(19) United States
(12) Patent Application Publication
(10) Pub. No.: US 2025/0078845 A1
(43) Pub. Date: Mar. 6, 2025

(54) LOSSLESS AUDIO CODING FOR MULTICHANNEL HIERARCHICAL RECONSTRUCTION

(71) Applicant: Samsung Electronics Co., Ltd., Suwon-si (KR)

(72) Inventor: Toni M. Hirvonen, Santa Clarita, CA (US)

(21) Appl. No.: 18/678,427

(22) Filed: May 30, 2024

Related U.S. Application Data
(60) Provisional application No. 63/535,239, filed on Aug. 29, 2023.

(51) Int. Cl. G10L 19/00; G10L 19/008

(52) U.S. Cl. CPC G10L 19/0017; G10L 19/008

(57) ABSTRACT

One embodiment provides a computer-implemented method that includes providing a hierarchical lossless audio reconstruction process including a hierarchy of unconstrained audio mixes for an audio content. Using the hierarchical lossless audio reconstruction process, each unconstrained audio mix in the hierarchy for the audio content is reconstructed, except a first unconstrained mix in the hierarchy, based on a previous unconstrained audio mix in the hierarchy.

### CROSS-REFERENCE TO RELATED APPLICATIONS

This application claims the priority benefit of U.S. Provisional Patent Application Ser. No. 63/535,239, filed on Aug. 29, 2023, which is incorporated herein by reference in its entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### TECHNICAL FIELD

One or more embodiments relate generally to immersive audio, and in particular, to providing preservation of artistic intention for audio content.

### BACKGROUND

Immersive audio is gaining popularity, and related tools for consumers audio may be desirable. The same content increasingly has many different versions, mainly because of different multichannel listening setups, such as 5.1 and 7.1.4. mix. In addition to current releases, legacy content is increasingly being mixed and mastered to new formats. Thus, either sending many versions of the same content is required, or the content creator has to rely on a blind automatic mixing process. Lossy coding/compression is an option but difficult to optimize perceptually.

### SUMMARY

One embodiment provides a computer-implemented method that includes providing a hierarchical lossless audio reconstruction process including a hierarchy of unconstrained audio mixes for an audio content. Using the hierarchical lossless audio reconstruction process, each unconstrained audio mix in the hierarchy for the audio content is reconstructed, except a first unconstrained mix in the hierarchy, based on a previous unconstrained audio mix in the hierarchy.

Another embodiment includes a non-transitory processor-readable medium that includes a program that when executed by a processor provides preservation of artistic intention for audio content, that includes providing, by the processor, a hierarchical lossless audio reconstruction process including a hierarchy of unconstrained audio mixes for an audio content. The processor further provides reconstructing, using the hierarchical lossless audio reconstruction process, each unconstrained audio mix in the hierarchy for the audio content, except a first unconstrained mix in the hierarchy, based on a previous unconstrained audio mix in the hierarchy.

Still another embodiment provides an apparatus that includes a memory storing instructions, and at least one processor executes the instructions including a process configured to provide a hierarchical lossless audio reconstruction process including a hierarchy of unconstrained audio mixes for an audio content. The process is further configured to reconstruct, using the hierarchical lossless audio reconstruction process, each unconstrained audio mix in the hierarchy for the audio content, except a first unconstrained mix in the hierarchy, based on a previous unconstrained audio mix in the hierarchy.

These and other features, aspects and advantages of the one or more embodiments will become understood with reference to the following description, appended claims and accompanying figures.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 is an example illustrating a popular consumer scenario flow from content creation to consumer;

FIG. 2 illustrates a standard predictor that uses p samples of the same audio channel for prediction of one sample;

FIG. 3 illustrates a predictor that uses all channels' past samples from p timesteps for prediction of one sample;

FIG. 4 illustrates a predictor that adds the use of current timestep samples from the downmix, according to some embodiments; and

FIG. 5 illustrates a process for preservation of artistic intention for audio content, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A description of example embodiments is provided on the following pages. The text and figures are provided solely as examples to aid the reader in understanding the disclosed technology. They are not intended and are not to be construed as limiting the scope of this disclosed technology in any manner. Although certain embodiments and examples have been provided, it will be apparent to those skilled in the art based on the disclosures herein that changes in the embodiments and examples shown may be made without departing from the scope of this disclosed technology.

Some embodiments relate generally to immersive audio, and in particular, to providing preservation of artistic intention for audio content. One embodiment provides a computer-implemented method that includes providing a hierarchical lossless audio reconstruction process including a hierarchy of unconstrained audio mixes for an audio content. Using the hierarchical lossless audio reconstruction process, each unconstrained audio mix in the hierarchy for the audio content is reconstructed, except a first unconstrained mix in the hierarchy, based on a previous unconstrained audio mix in the hierarchy.

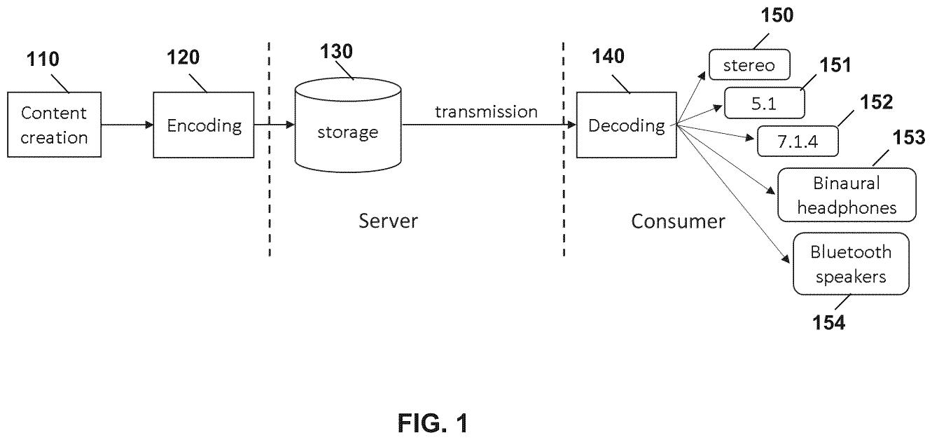

FIG. 1 is an example illustrating a popular consumer scenario flow from content creation to consumer. In the case of blind audio content upmixing, the original artistic intent is not guaranteed to be preserved despite the sophistication of such systems, making them less than ideal. In case upmix is available at the encoder, an alternative to blind upmixing is audio coding. Unfortunately, lossy multichannel coding is difficult to optimize perceptually. There is a need for exact artistic control of immersive reproduction in all situations. Lossless coding is a viable option to address concerns related to both blind upmixing and lossy coding. Despite the increased bandwidth, as transmission methods and network capacities have constantly improved, the need for extremely low bitrates is no longer a similar concern as before. However, improvements for the standard lossless bandwidth are still in demand. The basic principles of lossless coding can include: 1) a predictor model that is used to estimate the signal, and 2) the prediction residual (error) that is entropy coded. Compared to some lossless coding, there can be other more sophisticated predictors for lossless immersive audio. In the case of multichannel audio, however, these models are insufficient. As such, an improved approach(es) for immersive lossless audio predictors would be advantageous.

In some instances, such as when the immersive audio content creator desires to ensure that the artistic intention of multichannel content is perfectly preserved, and they provide multiple mixes (or versions) of the same content, their only option currently is to code all audio mixes separately with a standard lossless codec such as free lossless audio codec (FLAC). Having several versions (mixes) for the same content presents questions regarding how to handle storage and transmission most efficiently. When looking at the most popular consumption scenario, e.g., music streaming, the situation is approximately as shown in FIG. 1. Conventionally, the flow from the content creator commences with content creation 110 and encoding 120. At the Server side, the encoding operation can be processing-heavy, since it is done rarely. Even though storage 130 is relatively inexpensive, at the same time new immersive formats put high demands on the capacity. After transmission from the server side, at the consumer side, the assumption is typically that only one version of the content is needed. The received transmission of the encoded content is decoded at the decoding block 140, which decodes the content in different formats (stereo 150, 5.1 audio 151, 7.1.4 audio 152) and to different listening devices (binaural headphones 153, BLUETOOTH® speakers 154). There is feedback informing the request to the server, and only one version is transmitted at a time. There may be some issues, however, including: 1) large server-side bitrate/content storage for content containing many versions; 2) different versions result in multiple separate files, which may be confused with other files that do not represent the artistic intention (such as old versions of the same mix, etc.); and 3) in case there is a need to switch content version (e.g. from 5.1 audio to stereo), there is a distinct gap/latency if the server needs to change the version that is transmitted to the consumer on the fly.

One or more embodiments can be useful: when transmitting multiple versions to the consumer side, for example for smooth switching between formats, simultaneous listening of different formats in multiple rooms etc.; and saving server side storage in scenarios where only one version is transmitted at a time.

The principle of lossless coding is well-known: 1) a predictor model estimates the signal, and 2) the prediction residual error is entropy coded. However, there is room for innovation, especially when having several versions of the same content. A better alternative would be to use a process that jointly exploits the correlations between the different mixes to reduce the bitrate when coding them together. A special case of this is a hierarchical lossless reconstruction process where each mix (except the first in the hierarchy) is reconstructed based on the previous mix.

Meridian Lossless Packing (MLP) is a lossless compression technique used for compressing pulse-code modulation (PCM) audio that implements a version of hierarchical coding, which enables decoding a linear stereo downmix directly from a 6-channel bitstream without decoding the upmix first, and optionally decoding both stereo-and 5.1 mixes. This system relies on linear channel-combination downmixes, and the downmix coefficients being locally static in order to limit the amount of side information.

The current methods still have issues, such as: 1) the present hierarchical lossless audio coding methods are constrained to specific cases of locally static, linear channel-combination downmixes. The content creators do not have full freedom, or are forced to use general non-optimized coding methods; and 2) large server-side bitrate/content storage requirements, and lack of organization for content containing many non-constrained versions.

In one or more embodiments, the present technology provides a joint hierarchical lossless reconstruction process where each mix (except the first in a hierarchy) is reconstructed based on the previous mix in the hierarchy. Unlike conventional techniques, the process of some embodiments is not constrained to locally static, linear channel-combination downmixes. Also, disclosed technology results in a lower bitrate than a standard solution of coding the mixes separately.

One or more embodiments provide that multiple unconstrained mixes of the same audio content are to be stored together in a single container/storage and bitstream using joint reconstruction, in order to preserve the artistic intention. Some embodiments provide an extension where the content creation stage provides metadata on what specific signal processing operations were utilized to construct the downmixes at which temporal point, and that this information is utilized in the hierarchical lossless coding predictor.

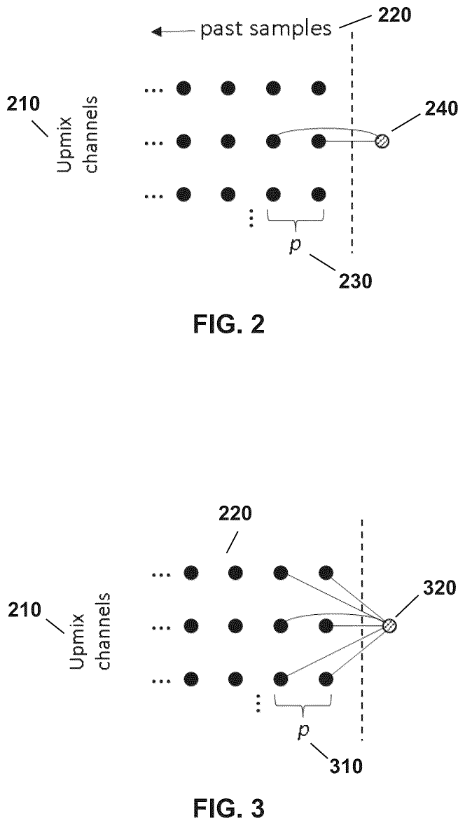

FIG. 2 illustrates a standard predictor that uses p samples 230 of the same audio channel for prediction of one sample 240. Note that the standard predictor process is shown for only one sample for clarity. The current sample to be predicted is sample 240, and the past samples of the upmix channel 210 signal are samples 220. Only the past p 230 samples of the same audio channel are used for the prediction of sample 240.

FIG. 3 illustrates a predictor that uses all channels' (upmix channels 210) past samples 220 from p 310 timesteps for prediction of one sample 320. However, this alone does not result in great benefit in compression.

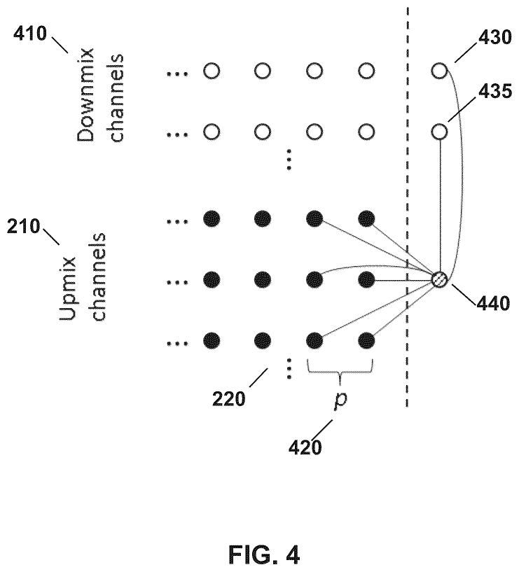

FIG. 4 illustrates a predictor that adds the use of current timestep samples from the downmix (downmix channels 410), according to some embodiments. Assume there are two (2) or more related mixes available for lossless reconstruction. The lowest mix in the hierarchy is reconstructed. The next mix (“upmix”, e.g., 5.1) from the upmix channels 210 is reconstructed using one of the previously reconstructed mixes (downmix, e.g., stereo). Lossless coding operates on coding the prediction residual of each frame with entropy coding. The better the predictor, the less bits are required. In one or more embodiments, an improved predictor that, in addition to previous upmix time samples (from upmix channels 210), operates on the current downmix sample 430, 435 (from the downmix channels 410) using it to improve prediction of the current upmix sample p 420 for the prediction sample 440. This is in contrast to a typical predictor solution that operates only on the past samples of the same channel.

In some embodiments, the current timestep samples are obtained from the downmix channels 410. This results in a notably better prediction and compression than conventional techniques. In one or more embodiments, the mixes do not need to be restricted. In conventional techniques the downmix is limited to linear, locally static channel combination of only the upmix channels. The often-used linear predictive coding algorithms such as Levinson recursion, are not suitable as the system of one or more embodiments do not use a Toeplitz system “standard predictor” (i.e., that is limited to single-channel and prediction source samples do not need to be a continuous time series). Some embodiments utilize general linear solvers such as the General Linear Solver (GELSD) optimized routine available in the free LAPACK. In one or more embodiments, the multichannel predictor parameters are jointly optimized and not limited to Toeplitz systems.

There is typically some correlation between the different channels of the downmix, especially if the number of downmix channels 410 is low. In one or more embodiments, performing a linear transform, which packs energy as much as possible to uncorrelated signals, is very beneficial after the predictor stage. Such transform can be calculated with known methods (e.g., Principal Component Analysis (PCA) or Singular Value Decomposition (SVD)). The tradeoff for the performance is increased computational encoder cost, which is not an issue as it is not performed on the consumer side. Decoding is still relatively inexpensive computationally.

Some embodiments use the coding process of FIG. 4 and add the different coded mix bitstreams to the same digital file container. This container ties together all the different mixes of the same content in the storage/server side. Additionally, for example multi-room listening setups, streaming several versions of the same content for different listening layouts can provide more seamless experience.

In addition to the embodiments of FIG. 4 (upmix-associated downmix of the same content), one or more embodiments can include different versions of the same mix that are somehow correlated (e.g., the studio 5.1 mix to live 5.1 version, several different stereo versions generated by different audio engineers, etc.). Users may also want to add mixes (as well as the associated predictor parameters) to an existing container afterwards.

Even though the mixes of some embodiments do not need to be restricted, in some embodiments the lossless prediction system of FIG. 4 rely on the fact that the mixes nevertheless have some correlation to exploit in compression. Some mixing operations are easier to exploit with the blind predictor models than others. In one or more embodiments, content creation metadata can be helpful to build more sophisticated, signal-adaptive predictors. For example, nonlinear signal operations, such as reverb or channel decorrelation that can be used to create different mixes, can be helpful to inform the lossless coder about their exact nature. Then if both encoder and decoder implement signal operations or signal models that are able to emulate the mixing operation, more efficient lossless prediction can be achieved. Additionally, information about the dynamics of the downmix process can help prediction. Even a linear downmix operation can be difficult to capture with a predictor that is static per signal frame, in case the downmix varies within the frame.

In one or more embodiments, the metadata creation at the mixing stage, and the parsing at the coding stage can both be automated by trained machine learning models. This way there is no need to manually compose the metadata and the associated coder operations.

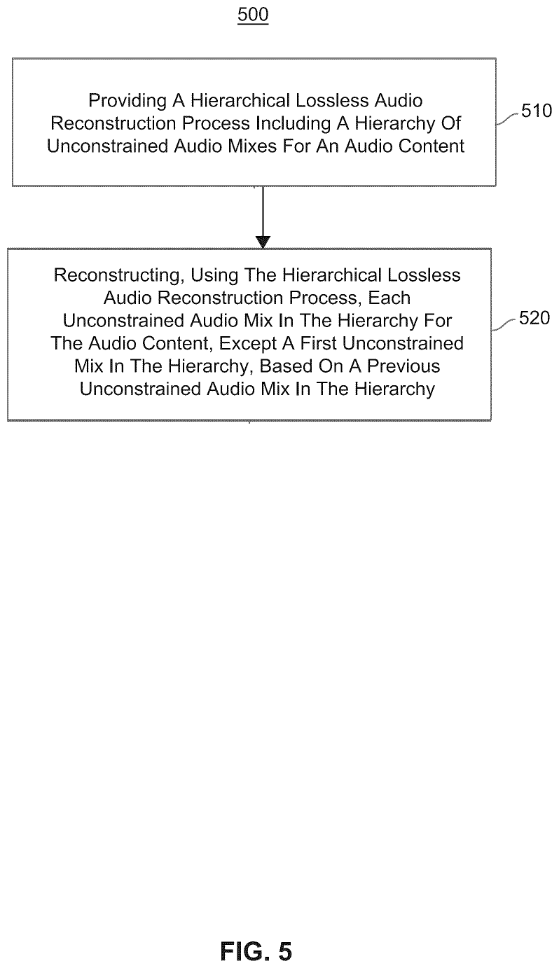

FIG. 5 illustrates a process 500 for preservation of artistic intention for audio content, according to some embodiments. In block 510, process 500 provides a hierarchical lossless audio reconstruction process including a hierarchy of unconstrained audio mixes for an audio content (e.g., FIG. 4 (e.g., destined for playing on an electronic device, such as televisions, smart phones, wearable devices, tablets, laptops, stereo devices/systems, automotive audio systems, headsets, etc.)). In block 520, process 500 reconstructs, using the hierarchical lossless audio reconstruction process, each unconstrained audio mix in the hierarchy for the audio content, except a first unconstrained mix in the hierarchy, based on a previous unconstrained audio mix in the hierarchy.

In some embodiments, process 500 further includes storing multiple unconstrained mixes of the audio content together in a digital file container and bitstream, and utilizing the hierarchical lossless audio reconstruction process to preserve artistic intention for the audio content.

In one or more embodiments, process 500 additionally includes adding different coded mix bitstreams to the digital file container.

In some embodiments, process 500 further includes providing metadata, during creation of the audio content, that indicates specific signal processing operations that are utilized to construct one or more downmixes at one or more temporal points.

In one or more embodiments, process 500 additionally includes the feature that the metadata is utilized in a hierarchical lossless coding predictor.

In some embodiments, process 500 further includes the feature of that the metadata is created using machine learning during a mixing stage and parsed during a coding stage.

In one or more embodiments, process 500 additionally includes the feature that each unconstrained audio mix in the hierarchy for the audio content comprise different versions of a same mix that are correlated.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

In one or more embodiments, with immersive lossless audio, the content creators have assurance that their artistic intent is reproduced as accurately as possible at least in terms of lack of coding artifacts. In some embodiments, the disclosed technology provides container format containing several “sanctioned” mixes, and has the benefit of further controlling the artistic intent in terms of spatial reproduction. For immersive content, efficient compression becomes especially important since the whole content creation-consumer chain operates online over ordinary Internet. The disclosed technology additionally improves the bitrate significantly in the hierarchical reconstruction.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A computer-implemented method comprising:
providing a hierarchical lossless audio reconstruction process including a hierarchy of unconstrained audio mixes for an audio content; and
reconstructing, using the hierarchical lossless audio reconstruction process, each unconstrained audio mix in the hierarchy for the audio content, except a first unconstrained mix in the hierarchy, based on a previous unconstrained audio mix in the hierarchy.

2. The method of claim 1, further comprising:
storing multiple unconstrained mixes of the audio content together in a digital file container and bitstream; and
utilizing the hierarchical lossless audio reconstruction process to preserve artistic intention for the audio content.

3. The method of claim 2, further comprising:
adding different coded mix bitstreams to the digital file container.

4. The method of claim 1, further comprising:
providing metadata, during creation of the audio content, that indicates specific signal processing operations that are utilized to construct one or more downmixes at one or more temporal points.

5. The method of claim 4, wherein the metadata is utilized in a hierarchical lossless coding predictor.

6. The method of claim 5, wherein the metadata is created using machine learning during a mixing stage and parsed during a coding stage.

7. The method of claim 1, wherein each unconstrained audio mix in the hierarchy for the audio content comprise different versions of a same mix that are correlated.

8. A non-transitory processor-readable medium that includes a program that when executed by a processor provides preservation of artistic intention for audio content, comprising:
providing, by the processor, a hierarchical lossless audio reconstruction process including a hierarchy of unconstrained audio mixes for an audio content; and
reconstructing, by the processor, using the hierarchical lossless audio reconstruction process, each unconstrained audio mix in the hierarchy for the audio content, except a first unconstrained mix in the hierarchy, based on a previous unconstrained audio mix in the hierarchy.

9. The non-transitory processor-readable medium of claim 8, further comprising:
storing, by the processor, multiple unconstrained mixes of the audio content together in a digital file container and bitstream; and
utilizing, by the processor, the hierarchical lossless audio reconstruction process to preserve artistic intention for the audio content.

10. The non-transitory processor-readable medium of claim 9, further comprising:
adding, by the processor, different coded mix bitstreams to the digital file container.

11. The non-transitory processor-readable medium of claim 8, further comprising:
providing, by the processor, metadata, during creation of the audio content, that indicates specific signal processing operations that are utilized to construct one or more downmixes at one or more temporal points.

12. The non-transitory processor-readable medium of claim 11, wherein the metadata is utilized in a hierarchical lossless coding predictor.

13. The non-transitory processor-readable medium of claim 12, wherein the metadata is created using machine learning during a mixing stage and parsed during a coding stage.

14. The non-transitory processor-readable medium of claim 8, wherein each unconstrained audio mix in the hierarchy for the audio content comprise different versions of a same mix that are correlated.

15. An apparatus comprising:
a memory storing instructions; and
at least one processor executes the instructions including a process configured to:
provide a hierarchical lossless audio reconstruction process including a hierarchy of unconstrained audio mixes for an audio content; and
reconstruct, using the hierarchical lossless audio reconstruction process, each unconstrained audio mix in the hierarchy for the audio content, except a first unconstrained mix in the hierarchy, based on a previous unconstrained audio mix in the hierarchy.

16. The apparatus of claim 15, wherein the process is further configured to:
store multiple unconstrained mixes of the audio content together in a digital file container and bitstream; and
utilize the hierarchical lossless audio reconstruction process to preserve artistic intention for the audio content.

17. The apparatus of claim 16, wherein the process is further configured to:
add different coded mix bitstreams to the digital file container.

18. The apparatus of claim 15, wherein the process is further configured to:
provide metadata, during creation of the audio content, that indicates specific signal processing operations that are utilized to construct one or more downmixes at one or more temporal points.

19. The apparatus of claim 18, wherein the metadata is utilized in a hierarchical lossless coding predictor, and the metadata is created using machine learning during a mixing stage and parsed during a coding stage.

20. The apparatus of claim 15, wherein each unconstrained audio mix in the hierarchy for the audio content comprise different versions of a same mix that are correlated.
